(19) United States
(12) Patent Application Publication
(10) Pub. No.: US 2013/0065783 A1
(43) Pub. Date: Mar. 14, 2013

(54) MICROARRAYS BASED ON ENZYME-MEDIATED SELF-ASSEMBLY

(71) Applicants: Mara G. Prentiss, Belmont, MA (US); Efraim Feinstein, Cambridge, MA (US); Claudia Danilowicz, Cambridge, MA (US)

(72) Inventors: Mara G. Prentiss, Belmont, MA (US); Efraim Feinstein, Cambridge, MA (US); Claudia Danilowicz, Cambridge, MA (US)

(73) Assignee: President and Fellows of Harvard College, Cambridge, MA (US)

(21) Appl. No.: 13/609,158

(22) Filed: Sep. 10, 2012

Related U.S. Application Data
(60) Provisional application No. 61/533,107, filed on Sep. 9, 2011.

(51) Int. Cl. C40B 30/04; C40B 40/06

(52) U.S. Cl. 506/9; 506/16

(57) ABSTRACT

Provided herein are systems and related methods comprising (i) short stretches (e.g., 9 to 24 bases) of single-stranded nucleic acid (e.g., DNA) capture probes coated with RecA and, in some instances, bound to a solid substrate, and (ii) double-stranded nucleic acid (e.g., DNA or RNA) target(s).

### RELATED APPLICATIONS

This application claims the benefit of U.S. provisional application Ser. No. 61/533,107, filed Sep. 9, 2011. The entire contents of the referenced application are incorporated herein by reference.

### BACKGROUND OF INVENTION

Self-assembly is an important feature of natural biological systems, and an increasingly important factor in diagnostic in vitro systems. Self-assembly of structures, such as double-stranded (e.g., double helix) DNA, using a single-step process based on free energy minimization is often not an efficient process.

### SUMMARY OF INVENTION

The invention relates in a broad sense to the use of Recombinase A (RecA) and RecA-like proteins in the synthesis of nanostructures. The methods provided herein exploit the finding that RecA and/or RecA-like proteins accurately and reproducibly combine and bind single-stranded and double-stranded nucleic acids to each other, provided the nucleic acids share a complementary sequence.

The invention is based in part on the finding of robust nucleic acid assembly systems having a strong non-linearity in the free energy of the resulting complexes as a function of the number of correctly matched contacts between nucleic acids. These systems overcome the deficiencies of prior art assembly methods. Strong non-linearities are very difficult to achieve physically. An alternative is to achieve accurate binding site recognition with a weak non-linearity. Proteins in the RecA family, including RecA and homologs thereof, and RecA-like proteins can facilitate accurate sequence recognition between single-stranded and double-stranded nucleic acids (e.g., DNA) for short nucleotide sequences (e.g., about 9 to 24 bases) without requiring ATP hydrolysis.

Aspects of the invention are based in part on the identification of a multi-step process with a weakly non-linear free energy that can be used to correctly self-assemble binding contacts (e.g., complementary DNA base pairs) into a structure (e.g., double-stranded DNA) in which all of the binding contacts are accurately matched (e.g., all are complementary base pairs) and in which any mismatch (e.g., any non-complementary base pair) drives rapid complete disassembly. The invention contemplates, inter alia, exploiting the use of proteins in the RecA family such as RecA protein (also referred to herein as RecA) or RecA-like proteins to facilitate accurate sequence recognition and binding between single-stranded DNA (ssDNA) and double-stranded DNA (dsDNA), optionally in the absence of ATP hydrolysis (e.g., in the presence of ATP-gamma or other non-hydrolyzable forms of ATP).

The stability of the structure formed by the homologous binding contacts and the accuracy of the discrimination between homologous and non-homologous binding contacts depends in part on sequence length. Under most conditions, discrimination is achieved using short sequences. In some embodiments, the ssDNA and dsDNA bound by RecA and/or RecA-like proteins are about 9 to about 24 nucleotides in length. The length may be significant in instances where it is important to match and bind nucleic acids that are completely complementary throughout their length. In a RecA-mediated process, the stability of binding of complementary ssDNA and dsDNA that are 9 to 24 nucleotides in length is strong enough that the presence of additional flanking nucleotide sequence that is not complementary does not disrupt the association between the ssDNA and dsDNA species. Accordingly, the invention, in some embodiments, contemplates performing the assembly methods provided herein in the presence of RecA and/or RecA-like proteins using nucleic acids that are 9 to 24 nucleotides in length. In some embodiments, the nucleic acids are 20 to 24 nucleotides in length. In some instances, the nucleic acids are longer.

These assembly methods are referred to herein as RecA-mediated assembly. It is to be understood that the invention is described herein, in some instances, in the context of RecA for convenience and brevity and that the invention means to embrace the use of RecA and/or RecA-like proteins. Thus, terms such as RecA-mediated processes (e.g., RecA-mediated assembly) are intended to embrace processes mediated by RecA-like proteins as well.

The invention contemplates and provides compositions and methods comprising nucleic acids bound by RecA and/or RecA-like proteins to drive, guide and control nanostructure synthesis and other nanoscale (or microscale) processes. It is to be understood that RecA is involved in processes mediating nucleic acids. For convenience and brevity, the invention will be described, in some instances, in terms of DNA but is meant to embrace nucleic acids. Thus, RecA-mediated processes involving DNA is intended to embrace RecA-mediated processes involving RNA and other nucleic acids as well. In any given process or system, the ssDNA ranges in size from 9 to 24 bases (or longer, in some instances) and has a complementary sequences in dsDNA. It is to be understood that, as used herein, a ssDNA that is complementary to a dsDNA means that the ssDNA nucleotide sequence is complementary to the nucleotide sequence of a strand of the dsDNA.

It is to be understood that the “self-assembly” processes of the invention denote processes in which nucleic acids are combined, typically in solution, and are bound to each other in a RecA-mediated reaction based on the complementary nature of the nucleic acids. Although the processes may be referred to herein as “self-assembly” they nevertheless employ RecA and/or RecA-like proteins.

The use of RecA and/or RecA-like proteins in the assembly methods provided herein increases the efficiency of synthesizing desired nanostructures or performing desired nanoscale processes as compared to conventional, non-RecA-mediated, self-assembly methods some of which involve combining nucleic acids of known sequence together and allowing them to self-hybridize based on complementarity and Watson-Crick pairing in a predetermined manner in the absence of RecA and/or RecA-like proteins. By contrast, the methods of the invention, which include RecA and/or RecA-like proteins, result in a higher yield of desired nanostructures and a greater proportion (or enrichment) of the desired nanostructures. Although not wishing to be bound by any particular mechanism or theory, it is believed that the increased efficiency (and thus yield and enrichment) of the RecA-mediated methods is due to the ability of RecA and/or RecA-like proteins to accurately and robustly match and bind short complementary sequences to each other. The involvement of RecA and/or RecA-like protein reduces the likelihood of mismatches (and thus the production of nucleic acid complexes that include such mismatches). Such mismatches and the structures that result therefrom are more common in classical, non-RecA-mediated, self-assembly methods, and they serve to reduce yield and enrichment of desired nanostructures.

In some aspects, provided herein are systems (e.g., DNA microarrays) and related methods comprising short stretches (e.g., 9 to 24 bases) of single-stranded nucleic acid (e.g., ssDNA), referred to herein as “capture probes,” bound to (e.g., coated with) RecA and/or RecA-like proteins, referred to herein as “capture probe complexes” (e.g., ssDNA-RecA complexes). In some embodiments, the capture probe complexes are attached to a solid substrate, and double-stranded nucleic acid (e.g., dsDNA) targets are added to the system. In some embodiments, the capture probes are coated with RecA and/or RecA-like proteins and may be referred to herein as “filaments.” In other aspects, capture probes are first attached to a solid substrate, and unbound RecA and/or RecA-like protein and double-stranded nucleic acid targets are added to the system consecutively or at the same time. In some embodiments, the capture probes are coated with RecA and/or RecA-like proteins after the capture probes are attached to the solid substrate. In yet other aspects, the double-stranded nucleic acid targets are attached to a solid substrate, and capture probe complexes are added to the system. In still other aspects, double-stranded nucleic acid targets are attached to a solid substrate, and capture probes and unbound RecA and/or unbound RecA-like proteins are added to the system consecutively or at the same time. In some embodiments, the capture probes are coated with RecA and/or RecA-like proteins before combining with the double-stranded nucleic acid target. In other embodiments, the RecA and/or RecA-like proteins are made available after combining the capture probes and double-stranded nucleic acid targets (e.g., ssDNA and the dsDNA).

The systems and methods provided herein may be used in a wide variety of applications. A wide variety of nucleic acid assays are known in the art, and the systems and methods of the present invention may be used in any of these for purposes of, inter alia, research, clinical, quality control, or field testing settings. Such assays include, but are not limited to, nucleic acid diagnostic assays, gene expression profiling, genotyping including single nucleotide polymorphism (SNP) detection, and sequencing such as sequencing by hybridization.

In some aspects of the invention, provided herein are nucleic acid arrays comprising a solid substrate that comprises a single-stranded nucleic acid bound to a recombinase, wherein the recombinase catalyzes the pairing of single-stranded nucleic acid with a complementary region of double-stranded nucleic acid. In some embodiments, the recombinase is a RecA protein, a RecA homolog, or a RecA-like protein. In some embodiments, the recombinase is RecA803, UvsX, Rad51A, Rad51B, Rad51C, Rad51D, XRCC2, XRCC3, Rad57, Dmc or combinations thereof. In some embodiments, the recombinase is purified.

In some embodiments, the single-stranded nucleic acid is about 9 to about 24 nucleotides in length. In some embodiments, the single-stranded nucleic acid is single-stranded deoxyribonucleic acid (DNA).

In some embodiments, the single-stranded nucleic acid is covalently bound to the solid substrate. In some embodiments, the solid substrate or a surface of the solid substrate is glass, nylon, plastic or silicon. In some embodiments, the solid substrate is a nucleic acid chip or a bead.

In some embodiments, the solid substrate comprises a plurality of nucleic acids and some or all nucleic acids within the plurality may be identical to each other and/or different from each other. In some embodiments, the solid substrate comprises about 100 to about 100,000 single-stranded nucleic acids per 1 cm² area of the substrate.

In some embodiments, the nucleic acid arrays further comprise a non-hydrolyzable nucleoside triphosphate. In some embodiments, the non-hydrolyzable nucleoside triphosphate is ATPγS, GTPγS or combinations thereof.

In other aspects of the invention, provided herein are kits comprising the nucleic acid array of any of the aspects and/or embodiments of the invention.

In some aspects of the invention, provided herein are kits comprising a solid substrate that comprises a single-stranded nucleic acid, and a recombinase that catalyzes the pairing of single-stranded nucleic acid with a complementary region of double-stranded nucleic acid. In some embodiments, the kits further comprise double-stranded nucleic acid, a non-hydrolyzable nucleoside triphosphate, and/or buffer. In some embodiments, the non-hydrolyzable nucleoside triphosphate is ATPγS, GTPγS or combinations thereof.

In some embodiments, the recombinase is a RecA protein, a RecA homolog, or a RecA-like protein. In some embodiments, the recombinase is RecA803, UvsX, Rad51A, Rad51B, Rad51C, Rad51D, XRCC2, XRCC3, Rad57, Dmc or combinations thereof. In some embodiments, the recombinase is purified.

In some embodiments, the single-stranded nucleic acid is about 9 to about 24 nucleotides in length. In some embodiments, the single-stranded nucleic acid is single-stranded deoxyribonucleic acid (DNA).

In some embodiments, the single-stranded nucleic acid is bound (e.g., covalently bound) to the solid substrate. In some embodiments, the solid substrate or a surface of the solid substrate is glass, nylon, plastic or silicon. In some embodiments, the solid substrate is a nucleic acid chip or a bead. In some embodiments, the solid substrate comprises about 100 to about 100,000 isolated single-stranded nucleic acids per 1 cm² area of the substrate.

In some aspects of the invention, provided herein are kits comprising a solid substrate that comprises double-stranded nucleic acid, and recombinase that catalyzes the pairing of single-stranded nucleic acid with complementary regions of double-stranded nucleic acid. In some embodiments, the kits further comprise single-stranded nucleic acid, a non-hydrolyzable nucleoside triphosphate and/or buffer. In some embodiments, the non-hydrolyzable nucleoside triphosphate is ATPγS, GTPγS or combinations thereof.

In some embodiments, the recombinase is a RecA protein, a RecA homolog, or a RecA-like protein. In some embodiments, the recombinase is RecA803, UvsX, Rad51A, Rad51B, Rad51C, Rad51D, XRCC2, XRCC3, Rad57, Dmc or combinations thereof. In some embodiments, the recombinase is purified.

In some embodiments, the single-stranded nucleic acid is about 9 to about 24 nucleotides in length. In some embodiments, the single-stranded nucleic acid is single-stranded deoxyribonucleic acid (DNA).

In some embodiments, the double-stranded nucleic acids are covalently bound to the solid substrate. In some embodiments, the solid substrate or a surface of the solid substrate is glass, nylon, plastic or silicon. In some embodiments, the solid substrate is a nucleic acid chip or bead. In some embodiments, the solid substrate comprises about 100 to about 100,000 double-stranded nucleic acids per 1 cm² area of the substrate.

It is to be understood that the nucleic acids of the invention may be isolated nucleic acids.

In some aspects of the invention, provided herein are methods comprising providing a solid substrate that comprises a single-stranded nucleic acid bound to recombinase, and contacting the single-stranded nucleic acid with double-stranded nucleic acid, wherein the recombinase catalyzes the pairing of single-stranded nucleic acid with complementary regions of double-stranded nucleic acid.

In some embodiments, the single-stranded nucleic acid is single-stranded deoxyribonucleic acid (ssDNA). In some embodiments, the double-stranded nucleic acid is double-stranded deoxyribonucleic acid (dsDNA) or double-stranded ribonucleic acid (dsRNA). In some embodiments, the double-stranded nucleic acid comprises a detectable label. In some embodiments, the detectable label is a fluorophore.

In some embodiments, the recombinase is a RecA protein, a RecA homolog or a RecA-like protein. In some embodiments, the recombinase is RecA803, UvsX, Rad51A, Rad51B, Rad51C, Rad51D, XRCC2, XRCC3, Rad57, Dmc or combinations thereof. In some embodiments, the recombinase is purified.

In some embodiments, the single-stranded nucleic acid is about 9 to about 24 nucleotides in length. In some embodiments, the single-stranded nucleic acid is bound (e.g., covalently bound) to the solid substrate. In some embodiments, the double-stranded nucleic acid is bound (e.g., covalently bound) to the solid substrate. In some embodiments, the solid substrate or a surface of the solid substrate is glass, nylon, plastic or silicon. In some embodiments, the solid substrate is a chip or a bead. In some embodiments, the solid substrate comprises about 100 to about 100,000 single-stranded (or double-stranded) nucleic acids per 1 cm² area of the solid substrate.

In some embodiments, the methods further comprise coating the single-stranded nucleic acids with the recombinase prior to the contacting step. In some embodiments, the methods further comprise denaturing the single-stranded nucleic acids (e.g., to remove secondary structure). In some embodiments, the methods further comprise contacting the single-stranded nucleic acids with the recombinase and a non-hydrolyzable nucleoside triphosphate. In some embodiments, the non-hydrolyzable nucleoside triphosphate is ATPγS, GTPγS or combinations thereof.

In other aspects of the invention, provided herein are methods comprising providing a solid substrate that comprises single-stranded nucleic acid; coating the single-stranded nucleic acid with recombinase, and contacting the single-stranded nucleic acid with double-stranded nucleic acid, wherein the recombinase catalyzes the pairing of single-stranded nucleic acid with complementary regions of double-stranded nucleic acid.

In some embodiments, the single-stranded nucleic acid is single-stranded deoxyribonucleic acid. In some embodiments, the double-stranded nucleic acid is double-stranded deoxyribonucleic acid or a double-stranded ribonucleic acid. In some embodiments, the double-stranded nucleic acid comprises a detectable label. In some embodiments, the detectable label is a fluorophore.

In various embodiments of the invention, the single-stranded nucleic acid may comprise a detectable label such as but not limited to a fluorophore.

In some embodiments, the recombinase is a RecA protein, a RecA homolog or a RecA-like protein. In some embodiments, the recombinase is RecA803, UvsX, Rad51A, Rad51B, Rad51C, Rad51D, XRCC2, XRCC3, Rad57, Dmc or combinations thereof. In some embodiments, the recombinase is purified.

In some embodiments, the single-stranded nucleic acid is about 9 to about 24 nucleotides in length. In some embodiments, the single-stranded nucleic acid is bound (e.g., covalently bound) to the solid substrate. In some embodiments, the solid substrate or a surface of the solid substrate is glass, nylon, plastic or silicon. In some embodiments, the solid substrate is a chip or a bead. In some embodiments, the solid substrate comprises about 100 to about 100,000 single-stranded nucleic acids per 1 cm² area of the solid substrate.

In some embodiments, the methods further comprise contacting the single-stranded nucleic acid with the recombinase and a non-hydrolyzable nucleoside triphosphate. In some embodiments, the non-hydrolyzable nucleoside triphosphate is ATPγS, GTPγS or combinations thereof.

In yet other aspects of the invention, provided herein are methods comprising providing a solid substrate that comprises double-stranded nucleic acid, and contacting the double-stranded nucleic acid with recombinase and single-stranded nucleic acid, wherein the recombinase catalyzes the pairing of single-stranded nucleic acid with complementary regions of double-stranded nucleic acid. In some embodiments, the recombinase is bound to the single-stranded nucleic acid prior to the contacting step.

In some embodiments, the single-stranded nucleic acid is a single-stranded deoxyribonucleic acid. In some embodiments, the double-stranded nucleic acid is double-stranded deoxyribonucleic acid or double-stranded ribonucleic acid. In some embodiments, the double-stranded nucleic acid or the single-stranded nucleic acid comprises a detectable label. In some embodiments, the detectable label is a fluorophore.

In some embodiments, the recombinase is a RecA protein, a RecA homolog or a RecA-like protein. In some embodiments, the recombinase is RecA803, UvsX, Rad51A, Rad51B, Rad51C, Rad51D, XRCC2, XRCC3, Rad57, Dmc or combinations thereof. In some embodiments, the recombinase is purified.

In some embodiments, the single-stranded nucleic acid is about 9 to about 24 nucleotides in length. In some embodiments, the single-stranded or the double-stranded nucleic acid is bound (e.g., covalently bound) to the solid substrate. In some embodiments, the solid substrate or a surface of the solid substrate is glass, nylon, plastic or silicon. In some embodiments, the solid substrate is a chip or a bead. In some embodiments, the solid substrate comprises about 100 to about 100,000 single-stranded or double-stranded nucleic acids per 1 cm² area of the solid substrate.

In some embodiments, the methods further comprise contacting the nucleic acids with the recombinase in the presence of a non-hydrolyzable nucleoside triphosphate. In some embodiments, the non-hydrolyzable nucleoside triphosphate is ATPγS, GTPγS or combinations thereof.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

FIG. 1. RecA-ssDNA binding to dsDNA. (A) Schematic representation of RecA-mediated reactions: incoming ssDNA (top, dark gray line), dsDNA (outgoing strand, top gray line; complementary strand, bottom gray line; Watson-Crick pairing, middle light gray line) and RecA, site I (light gray region of oval) and site II (dark gray region of oval). (B) Schematic representation of the extension and tension on dsDNA bound to RecA-ssDNA filaments with light gray highlighting base pairs under tension and light gray triangles indicating regions occupied by L1 and L2 loops and their attached alpha helices, which interact strongly with the incoming strand. (i) dsDNA bound to the pre-synaptic filament. (ii) dsDNA bound to a RecA-ssDNA filament in the post-strand exchange state.

FIG. 2 shows a graph demonstrating the length (extension, μm) of dsDNA bound and unbound to RecA as a function of applied force (pN) (top). FIG. 2 also show schematics of the nucleotide base pair spacing of B-form dsDNA, overstretched dsDNA and dsRNA bound to RecA site I.

FIG. 3 shows graphs demonstrating the effects of overstretching dsDNA.

FIG. 4 shows schematics of dsDNA (left), graphs demonstrating the effects of overstretching dsDNA (middle and right).

### DETAILED DESCRIPTION OF INVENTION

It has been discovered, in accordance with the invention, that a multi-step process with a weakly non-linear free energy can correctly self-assemble binding contacts (such as complementary nucleotides or bases) into a structure in which all of the binding contacts are accurately matched, and any mismatch drives rapid and complete disassembly. Accurate self-assembly is enhanced if the free energy of the testing state is slightly positive, even for correctly matched structures, provided that incorrectly matched structures have even more positive free energies. The free energy of the final assembled state must be lower than that of the disassembled state. This discovery has been applied to the process of nucleic acid homology recognition, providing a strategy for improving self-assembly processes and systems that use nucleic acid-comprising components such as, for example, improving the efficiency and accuracy of deoxyribonucleic acid (DNA) sequence matching in DNA microarrays.

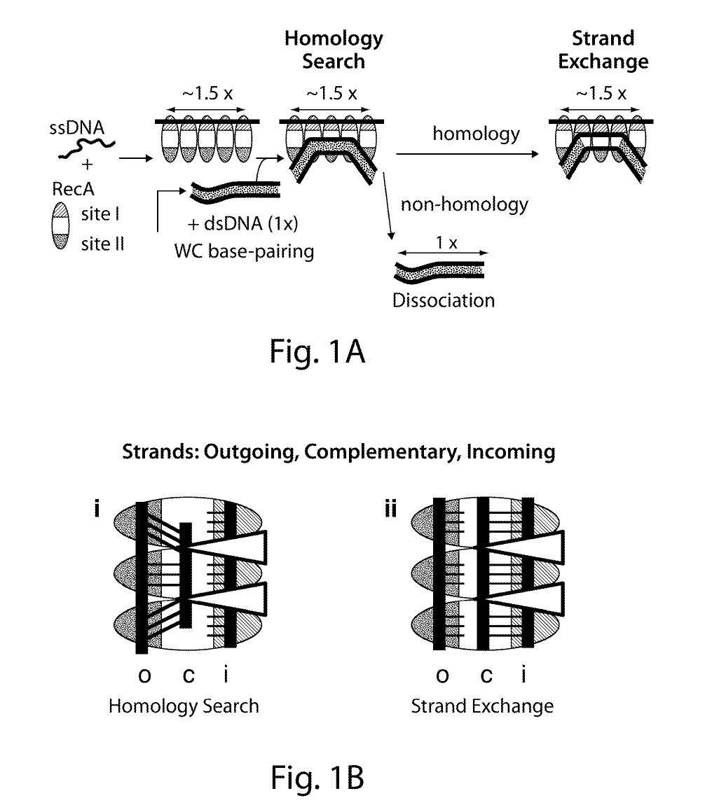

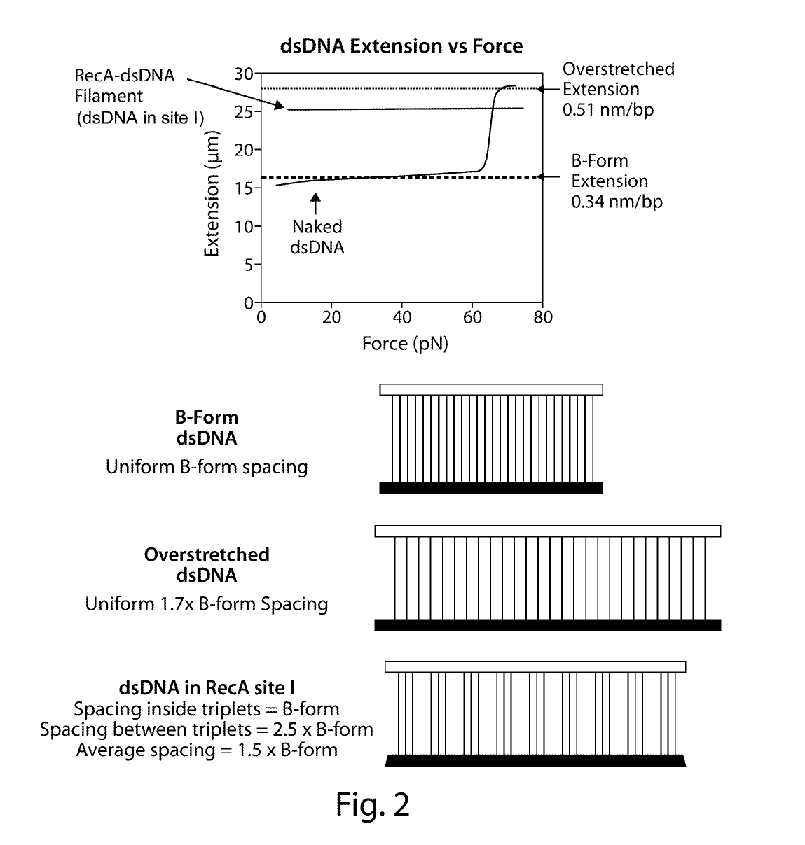

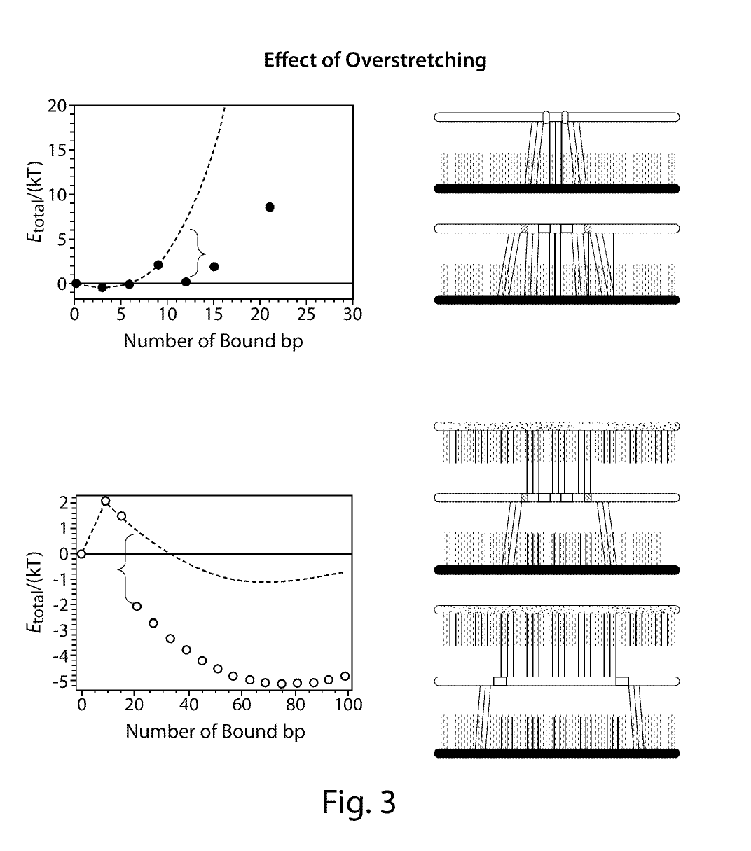

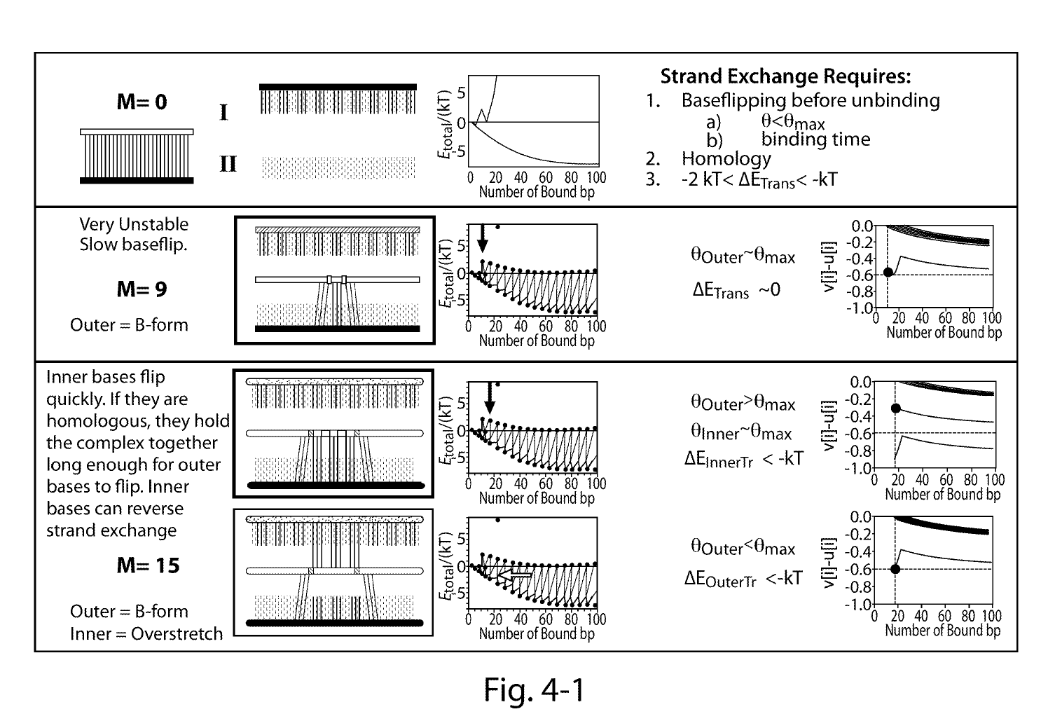

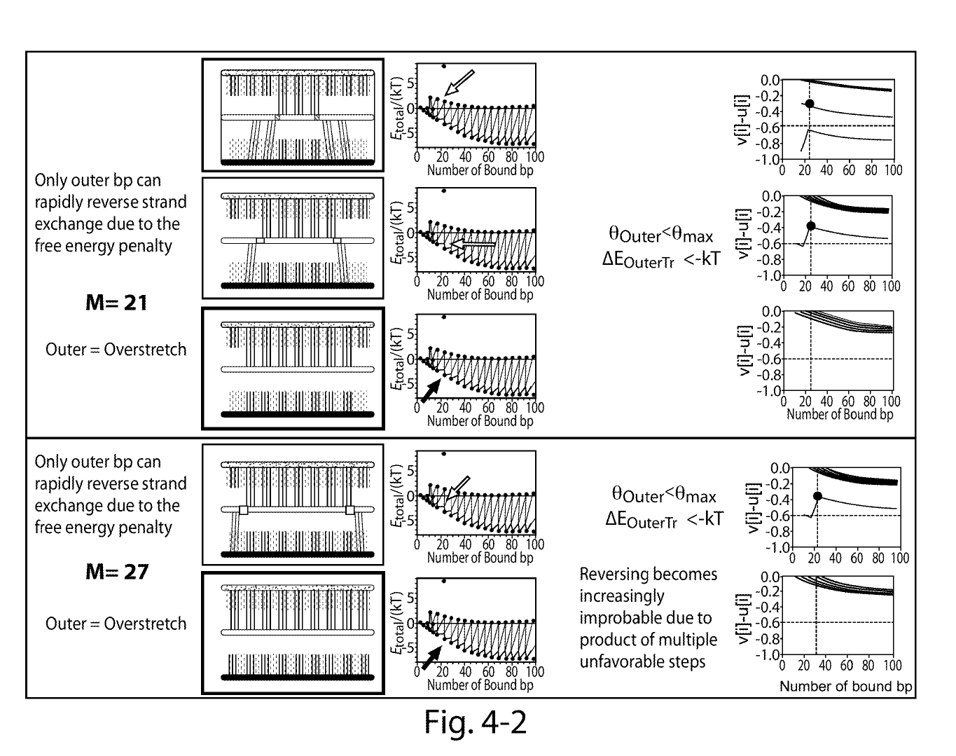

It has been unexpectedly and surprisingly discovered, in accordance with the invention, that by providing short stretches (e.g., 9 to 24 bases) of single-stranded nucleic acid (e.g., ssDNA) associated with (e.g., bound to) RecA and/or RecA-like proteins, which mediate the homology search/strand exchange process naturally, it is possible to improve efficiency and accuracy of this homology recognition process. RecA and/or RecA-like proteins (described in greater detail below) bind strongly and in long clusters to single-stranded nucleic acid such as ssDNA to form a nucleoprotein filament. RecA has more than one nucleic acid (e.g., DNA) binding site, and thus can hold a single-stranded nucleic acid and a double-stranded nucleic acid together. This feature makes it possible to catalyze a nucleic acid (e.g., DNA) synapsis reaction between, for example, a double-stranded DNA (dsDNA) and a homologous region of ssDNA. The ssDNA/RecA “filament” searches for homology along the dsDNA. The search process induces stretching of the DNA duplex, which enhances homology recognition (i.e., conformational proofreading) in at least the following ways: (1) it allows testing states to be free energetically unfavorable without incorporating a repulsive interaction; (2) it forces sequence recognition to be iterative; (3) it results in a non-linearity in the energy difference between successive structures in the multi-step assembly process; and (4) it prevents long regions of non-homologous dsDNA from binding to ssDNA/RecA filaments. The roles of RecA in homology searching and strand exchange are depicted in FIG. 1 and described in greater detail in Danilowicz et al., Nucleic Acid Research, 2012, 40(4):1717-27, incorporated herein by reference.

In some aspects of the invention, provided herein are systems such as, for example, nucleic acid arrays (e.g., DNA microarrays) and related methods that may comprise short stretches (e.g., 9 to 24 bases) of single-stranded nucleic acid (e.g., ssDNA, referred to herein in some instances as oligonucleotides or capture probes) coated with RecA or Rec-A like proteins to form capture probe complexes (e.g., ssDNA-RecA capture probe complexes). The capture probes may be attached to a solid substrate. In some embodiments, the capture probes are coated before they are attached to a solid substrate, and in some embodiments, the capture probes are coated after they are attached to a solid substrate. Such systems may further comprise double-stranded nucleic acid targets (e.g., dsDNA targets). In some embodiments, the double-stranded nucleic acid targets, rather than the capture probe complex, are attached to the solid substrate.

In other aspects of the invention, provided herein are methods of preparing the systems described herein, comprising, for example, coating short single-stranded nucleic acids (e.g., 9 to 24 base ssDNA oligonucleotides) with RecA and/or RecA-like protein to form capture probe complexes and covalently attaching the complexes to the surface of a solid substrate.

### RecA and/or RecA-Like Proteins

RecA family proteins, RecA homologs, and/or RecA-like proteins, may be used in accordance with the invention. “RecA protein,” also referred to herein as “recombinase A,” means an enzyme that catalyzes the pairing of single-stranded nucleic acid (e.g., ssDNA) with complementary regions of double-stranded nucleic acid (e.g., dsDNA). The recombinases of the invention include RecA family proteins, RecA homologs having essentially all or most of the same functions as RecA, and RecA-like proteins (e.g., RecA-like recombination proteins). A “RecA-like protein” refers to a protein that has essentially all or most of the same functions as RecA, particularly: (i) the recombinase protein properly binds to and positions a single-stranded nucleic acid (e.g., ssDNA) to its homologous double-stranded nucleic acid (e.g., dsDNA) target and (ii) the single-stranded nucleic acid- recombinase protein (e.g., ssDNA-RecA) complex efficiently finds and binds to complementary endogenous sequences. RecA-like proteins include RecA mutant proteins and recombinant forms of RecA.

The most well-characterized RecA protein is from the bacterium E. coli and the homologous protein in humans is RAD51. Recombinases according to the invention may be from a bacterial cell, such as Escherichia spp., Streptomyces spp., Zymonas spp., Acetobacter spp., Citrobacter spp., Synechocystis spp., Rhizobium spp., Clostridium spp., Corynebacterium spp., Streptococcus spp., Xanthomonas spp., Lactobacillus spp., Lactococcus spp., Bacillus spp., Alcaligenes spp., Pseudomonas spp., Aeromonas spp., Azotobacter spp., Comamonas spp., Mycobacterium spp., Rhodococcus spp., Gluconobacter spp., Ralstonia spp., Acidithiobacillus spp., Microlunatus spp., Geobacter spp., Geobacillus spp., Arthrobacter spp., Flavobacterium spp., Serratia spp., Saccharopolyspora spp., Thermus spp., Stenotrophomonas spp., Chromobacterium spp., Sinorhizobium spp., Saccharopolyspora spp., Agrobacterium spp. or Pantoea spp. In some embodiments, the RecA and/or RecA-like proteins may be from a yeast cell, such as Saccharomyces spp., Schizosaccharomyces spp., Pichia spp., Paffia spp., Kluyveromyces spp., Candida spp., Talaromyces spp., Brettanomyces spp., Pachysolen spp., Debaryomyces spp., Yarrowia spp. and industrial polyploid yeast strains. Other non-limiting examples of fungi include Aspergillus spp., Pennicilium spp., Fusarium spp., Rhizopus spp., Acremonium spp., Neurospora spp., Sordaria spp., Magnaporthe spp., Allomyces spp., Ustilago spp., Botrytis spp., and Trichoderma spp. In some embodiments, the RecA and/or RecA-like proteins may be from Caenorhabditis spp., Drosophila spp., or Leishmania spp. In some embodiments, heat-resistant RecA and/or RecA-like proteins from, e.g., Thermus thermophiles bacteria are used, or alternatively, specifically excluded or omitted. In some embodiments, the recombinase is isolated and/or purified. Other RecA family proteins are described at the UniProt website, incorporated herein by reference.

In addition to the wild-type protein, a number of mutant RecA proteins have been identified (e.g., RecA803; see Madiraju et al., PNAS USA 85(18):6592 (1988); Madiraju et al., Biochem. 31:10529 (1992); Lavery et al., J. Biol. Chem. 267:20648 (1992)), which may be used in accordance with the various aspects and embodiments of the invention. Further, many organisms have RecA-like proteins with strand-transfer activities (e.g., Fugisawa et al., (1985) Nucl. Acids Res. 13: 7473; Hsieh et al., (1986) Cell 44: 885; Hsieh et al., (1989) J. Biol. Chem. 264: 5089; Fishel et al., (1988) Proc. Natl. Acad. Sci. (USA) 85: 3683; Cassuto et al., (1987) Mol. Gen. Genet. 208: 10; Ganea et al., (1987) Mol. Cell Biol. 7: 3124; Moore et al., (1990) J. Biol. Chem. 19: 11108; Keene et al., (1984) Nucl. Acids Res. 12: 3057; Kimeic, (1984) Cold Spring Harbor Svmp. 48: 675; Kmeic, (1986) Cell 44: 545; Kolodner et al., (1987) Proc. Natl. Acad. Sci. USA 84: 5560; Sugino et al., (1985) Proc. Natl. Acad. Sci. USA 85: 3683; Halbrook et al., (1989) J. Biol. Chem. 264: 21403; Eisen et al., (1988) Proc. NatI. Acad. Sci. USA 85: 7481; McCarthy et al., (1988) Proc. Natl. Acad. Sci. USA 85: 5854; Lowenhaupt et al., (1989) J. Biol. Chem. 264: 20568, which are incorporated herein by reference), which may be used in accordance with the various aspects and embodiments of the invention. Examples of such RecA-like proteins include RecA803, UvsX, and other RecA mutants and RecA-like proteins (Roca, A. l. (1990) Crit. Rev. Biochem. Molec. Biol. 25: 415), sep1 (Kolodner et al. (1987) Proc. Natl. Acad. Sci. (U.S.A.) 84:5560; Tishkoff et al. Molec. Cell. Biol. 11:2593), RuvC (Dunderdale et al. (1991) Nature 354: 506), DST2, KEM1, XRN1 (Dykstra et al. (1991) Molec. Cell. Biol. 11:2583), STP/DST1 (Clark et al. (1991) Molec. Cell. Biol. 11:2576), HPP-1 (Moore et al. (1991) Proc. Natl. Acad. Sci. (U.S.A.) 88:9067), and other target recombinases (Bishop et al. (1992) Cell 69: 439; Shinohara et al. (1992) Cell 69: 457); incorporated herein by reference). RecA and/or RecA-like proteins may be purified from E. coli strains, such as E. coli strains JC12772 and JC15369 (available from A. J. Clark and M. Madiraju, University of California-Berkeley, or purchased commercially). These strains contain the recA coding sequences on a “runaway” replicating plasmid vector (present at a high copy number in the cell). The RecA803 protein is a high-activity mutant of wild-type RecA. There exist several examples of recombinase proteins (many of which are described above), for example, from Drosophila, yeast, plant, human, and non-human mammalian cells, including proteins with biological properties similar to RecA (e.g., RecA-like recombinases), such as Rad51 (including Rad51A, B, C and D, XRCC2 and XRCC3), Rad57, Dmc from mammals and yeast, hereby incorporated by reference), which may be used in accordance with the various aspects and embodiments of the invention. In addition, portions or fragments of RecA or RecA-like proteins which retain recombinase biological activity, as well as variants or mutants of wild-type RecA which retain biological activity, such as the E. coli RecA803 mutant with enhanced recombinase activity or recombinases such as RecA that have been shuffled or altered to increase activity or for other reasons may be used herein. In some embodiments, any one of the foregoing RecA or RecA-like proteins may be specifically used in or excluded from the systems and methods described herein.

For DNA homology recognition, the process begins with the formation of a filament composed of RecA monomers around ssDNA. The RecA wraps around the DNA helically, with six monomers per revolution. The RecA helix is approximately 120 Å wide, with a central diameter of 25 Å. The carboxy termini of each monomer, which are believed to be important in interfilament interactions, project outward from the RecA helix. ATP is bound near the center of the helix. The RecA monomer contains three domains, a large central domain, surrounded by relatively small amino and carboxy domains. The central domain contains two DNA binding sites, one for binding ssDNA (Site I), and the other for binding dsDNA (Site II) and is involved in ATP binding. The central domain is primarily a twisted beta sheet with eight β-strands, bounded by eight α-helices. The amino domain contains a large α-helix and short β-strand, this α/β structure being important in formation of the RecA polymer. Three α-helices and a three-stranded β-sheet are found in the carboxy domain, which facilitate interfilament associations.

RecA monomers first polymerize to form a helical filament around ssDNA. The RecA filament has an amino domain-to-central domain polarity. The monomers are held together by a combination of hydrophobic and electrostatic interactions. The polymerization of RecA monomers into filaments involves extensive association of the amino domain of one monomer and the central domain of the next monomer in the filament (with a loss of 2,890 Å² of solvent-accessible surface area/monomer). This association can be visualized in a RecA dimer. During the polymerization process, RecA extends the ssDNA by 1.6 angstroms (Å) per axial base pair. Duplex DNA is then bound to the polymer. Bound dsDNA is partially unwound to facilitate base pairing between ssDNA and duplexed DNA. Once ssDNA has hybridized to a region of dsDNA, the duplexed DNA is further unwound to allow for branch migration. RecA has a binding site for ATP, as described above, the hydrolysis of which is required for release of the DNA strands from RecA filaments. ATP binding is also required for RecA-driven branch migration, but non-hydrolyzable analogs of ATP can be substituted for ATP in this process, suggesting that nucleotide binding alone can provide conformational changes in RecA filaments that promote branch migration. RecA monomers and RecA-like monomers may also polymerize to form a helical filament around other single-stranded nucleic acids such as, for example, ssRNA.

### Nucleic Acids

As used herein, the terms “nucleic acid” and/or “oligonucleotide” may refer to at least two nucleotides covalently linked together. A nucleic acid of the present invention will generally contain phosphodiester bonds, although in some cases, as outlined below, nucleic acid analogs are included that may have other backbones, comprising, for example, phosphoramide (Beaucage et al., Tetrahedron 49(10):1925 (1993) and references therein; Letsinger, J. Org. Chem. 35:3800 (1970); Sprinzl et al., Eur. J. Biochem. 81:579 (1977); Letsinger et al., Nucl. Acids Res. 14:3487 (1986); Sawai et al, Chem. Lett. 805 (1984), Letsinger et al., J. Am. Chem. Soc. 110:4470 (1988); and Pauwels et al., Chemica Scripta 26:141 91986)), phosphorothioate (Mag et al., Nucleic Acids Res. 19:1437 (1991); and U.S. Pat. No. 5,644,048), phosphorodithioate (Briu et al., J. Am. Chem. Soc. 111:2321 (1989), O-methylphophoroamidite linkages (see Eckstein, Oligonucleotides and Analogues: A Practical Approach, Oxford University Press), and peptide nucleic acid backbones and linkages (see Egholm, J. Am. Chem. Soc. 114:1895 (1992); Meier et al., Chem. Int. Ed. Engl. 31:1008 (1992); Nielsen, Nature, 365:566 (1993); Carlsson et al., Nature 380:207 (1996), all of which are incorporated by reference). Other analog nucleic acids include those with positive backbones (Denpcy et al., Proc. Natl. Acad. Sci. USA 92:6097 (1995); non-ionic backbones (U.S. Pat. Nos. 5,386,023, 5,637,684, 5,602,240, 5,216,141 and 4,469,863; Kiedrowshi et al., Angew. Chem. Intl. Ed. English 30:423 (1991); Letsinger et al., J. Am. Chem. Soc. 110:4470 (1988); Letsinger et al., Nucleoside & Nucleotide 13:1597 (1994); Chapters 2 and 3, ASC Symposium Series 580, “Carbohydrate Modifications in Antisense Research”, Ed. Y. S. Sanghui and P. Dan Cook; Mesmaeker et al., Bioorganic & Medicinal Chem. Lett. 4:395 (1994); Jeffs et al., J. Biomolecular NMR 34:17 (1994); Tetrahedron Lett. 37:743 (1996)) and non-ribose backbones, including those described in U.S. Pat. Nos. 5,235,033 and 5,034,506, and Chapters 6 and 7, ASC Symposium Series 580, “Carbohydrate Modifications in Antisense Research”, Ed. Y. S. Sanghui and P. Dan Cook. Nucleic acids containing one or more carbocyclic sugars are also included within the definition of nucleic acids (see Jenkins et al., Chem. Soc. Rev. (1995) pp 169-176). Several nucleic acid analogs are described in Rawls, C & E News Jun. 2, 1997 page 35. All of these references are hereby expressly incorporated by reference. These modifications of the ribose-phosphate backbone may be done to facilitate the addition of labels, or to increase the stability and half-life of such molecules in physiological environments.

The nucleic acids may be single-stranded (ss) or double-stranded (ds), as specified, or may contain portions of both single-stranded or double-stranded sequence. The nucleic acid may be DNA, both genomic and cDNA, RNA or a hybrid, where the nucleic acid contains any combination of deoxyribo- and ribonucleotides, and any combination of bases, including uracil, adenine, thymine, cytosine, guanine, inosine, xathanine hypoxathanine, isocytosine, and isoguanine. As used herein, the term “nucleoside” includes nucleotides as well as nucleoside and nucleotide analogs, and modified nucleosides such as amino modified nucleosides. In addition, “nucleoside” includes non-naturally occurring analog structures. Thus, for example, the individual units of a peptide nucleic acid, each containing a base, are referred to herein as a nucleoside.

Methods of synthesizing the nucleic acids (e.g., ssDNA or dsDNA) are known in the art and are described, for example, in U.S. Pat. Nos. 5,143,854 and 5,445,934, herein incorporated in their entirety.

### Capture Probes

Unexpectedly and surprisingly, it has been found, in accordance with the invention, that the accuracy and efficiency of RecA-mediated homology searching/strand exchange is greatly improved by using a multi-step, iterative process using short stretches of single-stranded nucleic acid, such as ssDNA, capture probes (e.g., those attached to a solid substrate, described in greater detail below) less than 25 nucleotides in length, for example, 24, 23, 22, 21, or 20 nucleotides. In some embodiments, the ssDNA (or other single-stranded nucleic acid capture probe) is less than 20 nucleotides, for example 19, 18, 17, 16, 15, 14, 13, 12, 11, 10 or 9 nucleotides. In some embodiments, the ssDNA (or other single-stranded nucleic acid capture probe) provided herein is 9 to 24 nucleotides in length or any range in between. For example, the ssDNAs may be 9 to 23, 9 to 22, 9 to 21, 9 to 20, 9 to 19, 9 to 18, 9 to 17, 9 to 16, 9 to 15, 9 to 14, 9 to 13, 9 to 12, 9 to 11, 9 to 10, 10 to 24, 10 to 23, 10 to 22, 10 to 21, 10 to 20, 10 to 19, 10 to 18, 10 to 17, 10 to 16, 10 to 15, 10 to 14, 10 to 13, 10 to 12, or 10 to 11 nucleotides in length. In some embodiments, the ssDNAs are 11 to 24, 11 to 23, 11 to 22, 11 to 21, 11 to 20, 11 to 19, 11 to 18, 11 to 17, 11 to 16, 11 to 15, 11 to 14, 11 to 13, 11 to 12, 12 to 24, 12 to 23, 12 to 22, 12 to 21, 12 to 20, 12 to 19, 12 to 18, 12 to 17, 12 to 16, 12 to 15, 12 to 14, or 12 to 13 nucleotides in length. In some embodiments, the ssDNAs are 13 to 24, 13 to 23, 13 to 22, 13 to 21, 13 to 20, 13 to 19, 13 to 18, 13 to 17, 13 to 16, 13 to 15, 13 to 14, 14 to 24, 14 to 23, 14 to 22, 14 to 21, 14 to 20, 14 to 19, 14 to 18, 14 to 17, 14 to 16, or 14 to 15 nucleotides in length. In some embodiments, the ssDNAs are 15 to 24, 15 to 23, 15 to 22, 15 to 21, 15 to 20, 15 to 19, 15 to 18, 15 to 17, 15 to 16, 16 to 24, 16 to 23, 16 to 22, 16 to 21, 16 to 20, 16 to 19, 16 to 18, or 16 to 17 nucleotides in length. In some embodiments, the ssDNAs are 17 to 24, 17 to 23, 17 to 22, 17 to 21, 17 to 20, 17 to 19, 17 to 18, 18 to 24, 18 to 23, 18 to 22, 18 to 21, 18 to 20, or 18 to 19 nucleotides in length. In some embodiments, the ssDNAs are 19 to 24, 19 to 23, 19 to 22, 19 to 21, 19 to 20, 20 to 24, 20 to 23, 20 to 22, or 20 to 21 nucleotides in length. In some embodiments, the ssDNAs are 21 to 24, 21 to 23, 21 to 22, 22 to 24, 22 to 23, or 23 to 24 nucleotides in length. In some embodiments, the ssDNA is 9 to 19 nucleotides in length. In some embodiments, the ssDNA is greater than 24 nucleotides in length.

In some embodiments, the single-stranded nucleic acid (e.g., ssDNA) capture probes described herein are coated with RecA and/or RecA-like proteins. The conditions used to coat the capture probes with RecA and/or RecA-like proteins and non-hydrolyzable nucleoside triphosphate such as ATPγS are described herein. In some embodiments, capture probes are coated using GTPγS, mixes of ATPγS with rATP, rGTP and/or dATP, or dATP or rATP alone in the presence of an rATP generating system (Boehringer Mannheim). In some embodiments, various mixtures of GTPγS, ATPγS, ATP, ADP, dATP and/or rATP or other nucleosides may be used, for example, ATPγS and ATP or ATPγS and ADP.

An example of a coating reaction follows. The single-stranded nucleic acid (e.g., ssDNA) capture probe is denatured by heating in an aqueous solution at 95-100° C. for about five minutes, then placed in an ice bath for 20 seconds to about one minute, followed by centrifugation at 0° C. for approximately 20 sec. Denatured capture probe may be stored in a freezer at −20° C., or it may be immediately added at room temperature to a standard RecA coating reaction buffer containing ATPγS. RecA and/or RecA-like protein may then be added. Alternatively, RecA and/or RecA-like protein may be included with the buffer components and ATPγS before the probe is added. RecA coating of single-stranded nucleic acid (e.g., ssDNA) capture probe is initiated by incubating mixtures of capture probe and RecA and/or RecA-like proteins at 37° C. for about 10-15 min. RecA protein concentration tested during the reaction with the capture probe may vary depending on the size and the amount of added probe. RecA and/or RecA-like protein concentrations may range of 5 to 50 μM. The ratio of RecA/RecA-like protein:capture probe, in some instances, can range from about 3:1 and 1:3. RecA protein coating of capture probe may be performed in a standard 1× reaction. RecA reaction buffer may be 10× and comprise 100 mM Tris acetate (pH 7.5 at 37° C.), 20 mM magnesium acetate, 500 mM sodium acetate, 10 mM DTT, and 50% glycerol. A reaction mixture may contain the following components: (i) 0.2-4.8 mM ATPγS; and (ii) between 1-100 ng/μl of ssDNA capture probe(s). To this mixture, about 1-20 μl of RecA and/or RecA-like protein per 10-100 μl of reaction mixture may be added, for example, at about 2-10 mg/ml (purchased from Pharmacia or purified from natural sources). The final reaction volume may be in the range of about 10-500 μl. RecA/ or RecA-like protein coating of capture probe may be initiated by incubating the capture probe-RecA/ RecA-like protein mixtures at 37° C. for about 10-15 min. The invention is not so limited in this regards. Other coating reactions and conditions are contemplated herein and may be used in accordance with the aspects and embodiments of the invention.

While the foregoing coating process is directed to the coating of ssDNA, it is to be understood that dsDNA (or other single-stranded or double-stranded nucleic acid) can be coated in RecA or RecA-like. The nucleic acids may be prepared as needed, and then coated with the recombinase as described herein.

The coating of capture probe with RecA and/or RecA-like protein can be evaluated in a number of ways. In some embodiments, protein binding to DNA, for example, is examined using band-shift gel assays (McEntee et al., (1981) J. Biol. Chem. 256: 8835). Labeled probes may be coated with RecA and/or RecA-like protein in the presence of ATPγS and the products of the coating reactions may be separated by agarose gel electrophoresis. As the ratio of RecA and/or RecA-like protein monomers to nucleotides in the ssDNA capture probe increases, targeting probe's electrophoretic mobility decreases (or is hindered) due to RecA- or RecA-like protein-binding to the capture probe. Hinderance of mobility of the coated capture probe reflects the saturation of targeting nucleic acid with RecA and/or RecA-like protein. An excess of RecA and/or RecA-like monomers to DNA nucleotides is required for efficient RecA and/or RecA-like protein coating of the short, e.g., 9 to 24 base ssDNA capture probes, described herein (Leahy et al., (1986) J. Biol. Chem. 261: 954).

Another method for evaluating RecA and/or RecA-like protein binding to ssDNA, for example, is in the use of nitrocellulose fiber binding assays (Leahy et al., (1986) J. Biol. Chem. 261:6954; Woodbury, et al., (1983) Biochemistry 22(20):4730-4737. The nitrocellulose filter binding method is particularly useful in determining the dissociation-rates for capture probe complexes (e.g., ssDNA:RecA) using labeled probe. In the filter binding assay, capture probe complexes are retained on a filter while free ssDNA passes through the filter. This assay method is more quantitative for dissociation-rate determinations because the separation of capture probe complexes from free probe is very rapid.

In some embodiments, the capture probes may be synthesized, coated with RecA and/or RecA-like protein, and then attached (e.g., through surface engineering) to a substrate (e.g., solid surface) by, for example, a covalent bond to a chemical matrix (e.g., through epoxy-silane, amino-silane, lysine, polyacrylamide or others). The surface of the substrate may be glass, plastic, or a silicon chip, or microscopic beads. In some embodiments, the capture probes may be synthesized, attached to a surface, and then coated with RecA and/or RecA-like protein. For example, in some embodiments, nucleic acid arrays are produced using techniques (e.g., spotting or printing techniques) that attach short single-stranded capture probes (e.g., ssDNA of 9 to 24 nucleotides in length) to a substrate. In such embodiments, RecA and/or RecA-like protein may be added either before or after capture probe attachment to the substrate. For example, the capture probes may be prepared and attached to the substrate, then RecA and/or RecA-like protein may be added to the array to coat the individual capture probes that are attached to the substrate.

In some embodiments, microarrays can be constructed by the direct synthesis of ssDNA capture probes on solid surfaces.

In some embodiments, the capture probes (e.g., ssDNA capture probes) may be designed to hybridize to target sequences to determine the presence, absence or quantity of a target sequence in a sample. The short ssDNAs described herein, for example, may be 24 nucleotides in length. In some embodiments, the capture probes of the invention are designed to be perfectly complementary to 9 to 24 bases of the target sequence such that hybridization of the target nucleic acid and the capture probe of the present invention occurs with high accuracy and efficiency. In some embodiments, the capture probes are designed to be perfectly complementary to greater than 24 bases of the target sequence.

It is to be understood that the single-stranded nucleic acids of the invention can be labeled for detection (as described below for target nucleic acids).

### Target Nucleic Acids

In other aspects of the invention, provided herein are systems and methods for detecting and/or quantifying nucleic acids, such as target nucleic acids, in a sample. The target nucleic acids utilized herein may be any nucleic acid, for example, mammalian nucleic acids (e.g., human nucleic acids), non-mammalian nucleic acids such as, for example, plant nucleic acids, bacterial nucleic acids, microbial nucleic acids or viral nucleic acids. The target nucleic acid sample may be, for example, a nucleic acid sample from a biological sample such as, for example, one or more cells including cell lysate and crude cell lysates, tissues and tissue lysates, bodily fluids such as, for example, blood, urine, anal and vaginal secretions, semen, perspiration, lymphatic fluid, cerebrospinal fluid, and amniotic fluid, tissue culture cells, buccal swabs, mouthwashes, stool, tissues slices, biopsies aspirations; archeological samples such as, for example, bone and mummified tissue; environmental samples such as, for example, air, agricultural, water and soil samples; biological warfare agent samples; research samples; purified samples such as, for example, purified genomic DNA, and RNA; raw samples such as, for example, human, bacterial and viral DNA and genomic DNA. The sample may also contain mixtures of material from one source or from different sources. Target nucleic acids may be, for example, DNA, RNA, or the DNA product of RNA subjected to reverse transcription.

“Target nucleic acid” or “target sequence” (which may be used interchangeably herein) refers to double-stranded nucleic acid (e.g., dsDNA), as distinguished from short stretches of single-stranded nucleic acid (e.g., ssDNA) capture probes. In some embodiments, the target nucleic acid may be from a sample, or a secondary target such as a product of a reaction such as a PCR or other amplification reaction. For example, a target nucleic acid from a sample may be amplified to produce a secondary target that is detected; alternatively, an amplification step may be performed using a signal probe that is amplified, again producing a secondary target that is detected. The target sequence may be any length.

The target nucleic acid may be prepared using known techniques. For example, in some embodiments, the sample may be treated to lyse cells, using known lysis buffers, sonication, or electroporation, with purification and amplification occurring as needed, as will be appreciated by those in the art. In addition, the reactions outlined herein may be accomplished in a variety of ways, as will be appreciated by those in the art. In some embodiments, components of the reaction may be added simultaneously, or sequentially, in any order. In some embodiments, the reaction may include a variety of other reagents which may be included in the assays. Such reagents include, without limitation, salts, buffers, neutral proteins, e.g. albumin, and detergents, which may be used to facilitate optimal hybridization and detection, and/or reduce non-specific or background interactions. Reagents may also include those that otherwise improve the efficiency of the assay, such as protease inhibitors, nuclease inhibitors, or anti-microbial agents may be used, depending on the sample preparation methods and purity of the target.

Amplification of the target nucleic acid is typically performed prior to detection. Amplification methods include both target amplification and signal amplification, including, without limitation, polymerase chain reaction (PCR), ligation chain reaction (sometimes referred to as oligonucleotide ligase amplification OLA), cycling probe technology (CPT), strand displacement assay (SDA), transcription mediated amplification (TMA), nucleic acid sequence based amplification (NASBA), rolling circle amplification (RCA), and invasive cleavage technology. In addition, there are a number of variations of PCR which also may be used according to the invention including, without limitation, “quantitative competitive PCR” or “QC-PCR,” “arbitrarily primed PCR” or “AP-PCR,” “immuno-PCR,” “Alu-PCR,” “PCR single strand conformational polymorphism” or “PCR-SSCP,” “reverse transcriptase PCR” or “RT-PCR,” “biotin capture PCR,” “vectorette PCR,” “panhandle PCR,” and “PCR select cDNA subtraction,” among others. All of these methods require a primer nucleic acid (including nucleic acid analogs) that is hybridized to a target sequence to form a hybridization complex, and an enzyme is added that in some way modifies the primer to form a modified primer. For example, PCR generally requires two primers, dNTPs and a DNA polymerase; LCR requires two primers that adjacently hybridize to the target sequence and a ligase; CPT requires one cleavable primer and a cleaving enzyme; and invasive cleavage requires two primers and a cleavage enzyme. Thus, in some embodiments, a target nucleic acid is added to a reaction mixture that comprises the necessary amplification components, and a modified primer is formed which is then detected. In any one of the embodiments described herein, amplification methods may be specifically excluded.

The target nucleic acid (and/or the single-stranded nucleic acid) may be labeled for detection in a variety of ways. A variety of labeling techniques may be used. For example, either direct or indirect detection of the target products may be performed. “Direct” detection requires the incorporation of a label, for example, a detectable label, e.g., an optical label such as a fluorophore, into the target sequence. In such embodiments, the label(s) may be incorporated in a variety of ways: (1) the primers may comprise the label(s), for example attached to the base, a ribose, a phosphate, or to analogous structures in a nucleic acid analog; (2) modified nucleosides may be used that are modified at either the base or the ribose (or to analogous structures in a nucleic acid analog) with the label(s); these label-modified nucleosides may then be converted to the triphosphate form and incorporated into a newly synthesized strand by a polymerase; or (3) a label probe that is directly labeled and hybridizes to a portion of the target sequence may be used. Any of these methods may result in a newly synthesized strand or reaction product that comprises labels, which can be directly detected as outlined below.

Modified strands may comprise a detection label, which may be a primary label or a secondary label. Accordingly, detection labels may be primary labels (directly detectable) or secondary labels (indirectly detectable).

In some embodiments, the detection label may be a primary label. A primary label is one that can be directly detected, such as a fluorophore. In general, labels fall into three classes: a) isotopic labels, which may be radioactive or heavy isotopes; b) magnetic, electrical, thermal labels; and c) colored or luminescent dyes. Labels may also include enzymes (e.g., horseradish peroxidase) and magnetic particles. Examples include chromophores, phosphors, or fluorescent dyes. Examples of dyes include, without limitation, fluorescent lanthanide complexes, such as those of Europium and Terbium, fluorescein, rhodamine, tetramethylrhodamine, eosin, erythrosin, coumarin, methyl-coumarins, quantum dots (also referred to as “nanocrystals”: see U.S. Ser. No. 09/315,584, hereby incorporated by reference), pyrene, Malacite green, stilbene, Lucifer Yellow, Cascade Blue™, Texas Red, Cy dyes (e.g., Cy3, Cy5), alexa dyes, phycoerythin, bodipy, and others described in the 6th Edition of the Molecular Probes Handbook by Richard P. Haugland, hereby expressly incorporated by reference.

In some embodiments, a secondary detectable label is used. A secondary label is one that is indirectly detected; for example, a secondary label can bind or react with a primary label for detection, go or can act on an additional product to generate a primary label (e.g., enzymes). Secondary labels include, without limitation, one of a binding partner pair, chemically modifiable moieties, nuclease inhibitors, enzymes such as horseradish peroxidase, alkaline phosphatases, and luciferases.

In some embodiments, the secondary label is a binding partner pair. For example, the label may be a hapten or antigen, which will bind its binding partner. In some embodiments, the binding partner may be attached to a solid support to provide for separation of extended and non-extended primers. For example, binding partner pairs include, but are not limited to: antigens (such as proteins (including peptides)) and antibodies (including fragments thereof (e.g., FAbs)); proteins and small molecules, including biotin/streptavidin; enzymes and substrates or inhibitors; other protein-protein interacting pairs; receptor-ligands; and carbohydrates and their binding partners. Nucleic acid-nucleic acid binding proteins pairs may also be used according to the invention. In some embodiments, the smaller of the pair may be attached to the NTP for incorporation into the primer. Binding partner pairs include, but are not limited to, biotin and streptavidin, digeoxinin and antibodies (Abs).

In some embodiments, the binding partner pair comprises a primary detection label (for example, attached to the NTP and therefore to the extended primer) and an antibody that will specifically bind to the primary detection label. “Specifically bind” means that the partners bind with specificity sufficient to differentiate between the pair and other components or contaminants of the system. In some embodiments, the binding is sufficient to remain bound under the conditions of the assay, including wash steps to remove non-specific binding. In some embodiments, the dissociation constants of the pair may be less than about 10⁻⁴ to 10⁻⁶ M⁻¹, less than about 10⁻⁵ to 10⁻⁹ M⁻¹, or less than about 10⁻⁷ to 10⁻¹.

### Solid Substrates and Arrays

In some aspects of the invention, the single-stranded or double-stranded nucleic acids are attached (e.g., covalently attached) to a substrate. A “substrate,” as used herein, may refer to a material having a rigid or semi-rigid surface. Essentially, any conceivable substrate may be used herein. In some embodiments, the substrate (e.g., of a nucleic acid array) may be biological, nonbiological, organic, inorganic, or a combination of any of these, existing as particles, beads, strands, precipitates, gels, sheets, tubing, spheres, containers, capillaries, pads, slices, films, plates, or slides. The substrate may have any convenient shape, such as a disc, square, sphere, or circle. In some embodiments, the substrate may be flat or may take on a variety of alternative surface configurations. For example, the substrate may contain raised or depressed regions. The substrate and its surface may form a rigid support on which to carry out the reactions described herein. The substrate and its surface may also be chosen to provide appropriate light-absorbing characteristics. For instance, in some embodiments, the substrate may be a polymerized Langmuir Blodgett film, functionalized glass, Si, Ge, GaAs, GaP, SiO₂, SiN₄, modified silicon, or any one of a wide variety of gels or polymers such as (poly)tetrafluoroethylene, (poly)vinylidenedifluoride, polystyrene, polycarbonate, or combinations thereof. In some embodiments, the substrate is flat glass or single-crystal silicon with surface relief features of less than 10.

In some embodiments, surfaces on the solid substrate may be composed of the same material as the substrate. Thus, the surface may be composed of any of a wide variety of materials, for example, polymers, plastics, resins, polysaccharides, silica or silica-based materials, carbon, metals, inorganic glasses, membranes, or any of the above-listed substrate materials. In some embodiments, the surface may provide for the use of caged binding members, which are attached firmly to the surface of the substrate. In some embodiments, the surface will contain reactive groups, which could be carboxyl, amino, hydroxyl, or the like. In some embodiments, the surface may be optically transparent and may have surface Si—OH functionalities, such as are found on silica surfaces. In some embodiments, at least one surface of the substrate will be substantially flat, although in some embodiments it may be desirable to physically separate synthesis regions for different polymers with, for example, wells, raised regions, etched trenches, or the like. According to other embodiments, small beads may be provided as the surface or on the surface of a substrate. In some embodiments, the surface of the substrate is etched using well-known techniques to provide for desired surface features. For example, by way of the formation of trenches, v-grooves, mesa structures, or the like, the synthesis regions may be more closely placed within the focus point of impinging light, or be provided with reflective “mirror” structures for maximization of light collection from fluorescent sources, or the like.

In some embodiments, the surface of a substrate comprises 10³ or more nucleic acids (e.g., ssDNA) with different, known sequences covalently attached to the surface in discrete known regions, said 10³ or more nucleic acids occupying a total area of less than 1 cm² on said substrate, said nucleic acids having length of 24 bases or less. For example, in some embodiments, single-stranded nucleic acids may have 9, 10, 11, 12, 13, 14,15, 16, 17, 18, 19, 20, 21, 22, 23 or 24 nucleotides. In some embodiments, the surface of the substrate comprises less than 10³ nucleic acids occupying a total area of less than 1 cm². For example, in some embodiments there are about 900, about 800, about 700, about 600, about 500, about 400, about 300, about 200, or about 100 nucleic acids within a 1 cm² area. In some embodiments, nucleic acids may be longer than 24 nucleotides.

In some embodiments, the surface of a substrate comprises 10³ or more single-stranded nucleic acid-protein complexes (e.g., ssDNA-RecA complexes) with different, known sequences covalently attached to the surface in discrete known regions, said 10³ or more complexes occupying a total area of less than 1 cm² on said substrate, said complexes having different single-stranded nucleic acids with nucleotide sequences of 24 bases or less in length. For example, in some embodiments, single-stranded nucleic acids in a capture probe complex may have 9, 10, 11, 12, 13, 14,15, 16, 17, 18, 19, 20, 21, 22, 23 or 24 nucleotides. In some embodiments, the surface of the substrate comprises less than 10³ single-stranded nucleic acid capture probe complexes (ssDNA-RecA complexes) occupying a total area of less than 1 cm². For example, in some embodiments there are about 900, about 800, about 700, about 600, about 500, about 400, about 300, about 200, or about 100 complexes within a 1 cm² area. In some embodiments, single-stranded nucleic acids in a capture probe complex may have more than 24 nucleotides.

Any one of the foregoing substrates may be part of a system comprising double-stranded nucleic acid (e.g., dsDNA) targets added thereto.

Any of the methods provided herein may be used in combination with DNA microarray or gene chip technologies described herein and standard molecular biology techniques associated with such technologies. In some embodiments, the final DNA denaturation (melting) step of DNA microarray or gene chip technologies described herein and standard molecular biology techniques associated with such technologies may be omitted.

In some aspects of the invention, target sequences (optionally labeled) may be added to an array of capture probes. The present system finds particular utility in array formats, e.g., wherein there is a matrix of addressable microscopic locations (referred to herein as “addresses”). The size of the array may depend on the composition and end use of the array. Arrays containing from about two to many millions of different capture probes may be prepared, with very large arrays being possible. In some embodiments, the array may comprise from two to as many as a billion or more, depending on the size of the addresses and the substrate, as well as the end use of the array. Ranges for the arrays may be from about 100 to about 100,000 addresses per square centimeter. Due to the improved accuracy and efficiency conferred by the recombinases used herein, it may, in some embodiments, be desirable to lower the density of capture probes at any particular address.

Nucleic acids arrays are known in the art, and can be classified in a number of ways; both ordered arrays (e.g. the ability to resolve chemistries at discrete sites), and random arrays may be used as provided herein. Ordered arrays include, but are not limited to, those made using photolithography techniques (e.g., Affymetrix GeneChip™), spotting techniques e.g., Synteni and others), printing techniques (e.g., Hewlett Packard and Rosetta), three dimensional “gel pad” arrays, and bead arrays. The nucleic acid arrays described herein may can be manufactured in different ways, depending on the number of probes under examination, costs, customization requirements, and the type of scientific question being asked. In some embodiments, an array may have as few as about 10 probes, while in other embodiments, an array may have up to about 2.1 million micrometer-scale probes from commercial vendors. A nucleic acid array may be fabricated using a variety of technologies, including, without limitation, printing with fine-pointed pins onto glass slides, photolithography using pre-made masks, photolithography using dynamic micromirror devices, ink-jet printing and electrochemistry on microelectrode arrays.

“DNA microarray” may refer to a collection of microscopic nucleic acid (e.g., DNA) spots attached to a solid surface/substrate. The arrays of the invention may be single-stranded or double-stranded nucleic acid arrays. A DNA microarray may also be referred to as a “gene chip,” “DNA chip,” or “biochip.” In some embodiments of the invention, DNA microarrays may be used to measure the expression levels of large numbers of genes simultaneously or to genotype multiple regions of a genome. Each nucleic acid spot may contain picomoles (10⁻¹² moles) of a specific nucleic acid sequence, e.g., probes (or reporters). In some embodiments, specific ssDNA capture probes are coated with (e.g., bound by) RecA protein (e.g., see Example 1). These short sequences may be a short section of a gene or other DNA element that is used to hybridize a cDNA or cRNA sample (e.g., target) under, for example, high-stringency conditions. In some embodiments, probe-target hybridization is detected and quantified by detection of fluorophore-, silver-, or chemiluminescence-labeled targets to determine relative abundance of nucleic acid sequences in the target.

The core principle behind DNA microarrays is hybridization between two nucleic acid strands, the property of complementary nucleic acid sequences to specifically pair with each other by forming hydrogen bonds between complementary nucleotide base pairs. A high number of complementary base pairs in a nucleotide sequence means tighter non-covalent bonding between the two strands. Presented herein, in some embodiments, are methods of increasing the efficiency and accuracy of this complementary base pairing by utilizing RecA family protein (or homologs). After washing off of non-specific binding sequences, only strongly paired strands typically remain hybridized. Fluorescently-labeled dsDNA target sequences that bind to a ssDNA probe sequence generate a signal that depends on the strength of the hybridization determined by the number of paired bases, the hybridization conditions (e.g., temperature), and washing after hybridization. Total strength of the signal, from a spot (feature), typically depends upon the amount of target sample binding to the probes present on that spot. Microarrays use relative quantization in which the intensity of a feature is compared to the intensity of the same feature under a different condition, and the identity of the feature is known by its position.

In some embodiments, the nucleic acid arrays described herein may be spotted microarrays. In spotted microarrays, the probes may be oligonucleotides, cDNA or small fragments of PCR products that correspond to mRNAs. The probes may be synthesized prior to deposition on the array surface and then “spotted” onto glass. A common approach utilizes an array of fine pins or needles controlled by a robotic arm that is dipped into wells containing DNA probes and then depositing each probe at designated locations on the array surface. The resulting “grid” of probes represents the nucleic acid profiles of the prepared probes and is ready to receive complementary cDNA or cRNA “targets” derived from experimental or clinical samples. These arrays may be customized for each application provided herein.

In some embodiments, the nucleic acid arrays described herein may be oligonucleotide arrays. In oligonucleotide microarrays, for example, the probes may be short sequences designed to match parts of the sequence of known or predicted open reading frames. Although oligonucleotide probes may be used in “spotted microarrays”, the term “oligonucleotide array” may refer to a specific technique of manufacturing. In embodiments described herein, oligonucleotide arrays are produced by printing short (e.g., about 9 to about 24) oligonucleotide sequences designed to represent a single gene or family of gene splice-variants by synthesizing this sequence directly onto the array surface instead of depositing intact sequences. Techniques used to produce oligonucleotide arrays include photolithographic synthesis on a silica substrate where light and light-sensitive masking agents are used to “build” a sequence one nucleotide at a time across the entire array. Each applicable probe is selectively “unmasked” prior to bathing the array in a solution of a single nucleotide, then a masking reaction takes place and the next set of probes are unmasked in preparation for a different nucleotide exposure. After many repetitions, the sequences of every probe become fully constructed. More recently, Maskless Array Synthesis from NimbleGen Systems has combined flexibility with large numbers of probes.

In some embodiments, the nucleic acid arrays may be two-channel microarrays. Two-channel microarrays or two-color microarrays may be hybridized with cDNA prepared from two samples to be compared (e.g., diseased tissue versus healthy tissue) and that are labeled with two different fluorophores. Fluorescent dyes that may be used for cDNA labeling include Cy3, which has a fluorescence emission wavelength of 570 nm (corresponding to the green part of the light spectrum), and Cy5 with a fluorescence emission wavelength of 670 nm (corresponding to the red part of the light spectrum). The two Cy-labeled cDNA samples are mixed and hybridized to a single microarray that is then scanned in a microarray scanner to visualize fluorescence of the two fluorophores after excitation with a laser beam of a defined wavelength. Relative intensities of each fluorophore may then be used in ratio-based analysis to identify up-regulated and down-regulated genes.

In some embodiments, the nucleic acid arrays may be single-channel microarrays. In single-channel microarrays or one-color microarrays, the arrays provide intensity data for each probe or probe set indicating a relative level of hybridization with the labeled target. The intensity data indicates relative abundance when compared to other samples or conditions when processed in the same experiment. Each nucleic acid molecule (e.g., DNA or RNA) encounters protocol and batch-specific bias during amplification, labeling, and hybridization phases of the experiment making comparisons between genes for the same microarray uninformative. The comparison of two conditions for the same gene typically requires two separate single-dye hybridizations.

Any one of the embodiments describe herein may be used in any one or more of the following application or technologies:
Gene expression profiling. In an mRNA or gene expression profiling experiment, the expression levels of thousands of genes are simultaneously monitored to study the effects of certain treatments, diseases, and developmental stages on gene expression. For example, microarray-based gene expression profiling can be used to identify genes whose expression is changed in response to pathogens or other organisms by comparing gene expression in infected to that in uninfected cells or tissues.
Comparative genomic hybridization. Assessing genome content in different cells or closely related organisms.
GeneID. Small microarrays to check IDs of organisms in food and feed (like GMO [1]), mycoplasms in cell culture, or pathogens for disease detection, mostly combining PCR and microarray technology.
Chromatin immunoprecipitation (ChIP) on Chip. DNA sequences bound to a particular protein can be isolated by immunoprecipitating that protein (ChIP), these fragments can be then hybridized to a microarray (such as a tiling array) allowing the determination of protein binding site occupancy throughout the genome. Example protein to immunoprecipitate are histone modifications (H3K27me3, H3K4me2, H3K9me3, etc.), Polycomb-group protein (PRC2:Suz12, PRC1:YY1) and trithorax-group protein (Ash1) to study the epigenetic landscape or RNA Polymerase II to study the transcription landscape.
DamID. Analogously to ChIP, genomic regions bound by a protein of interest can be isolated and used to probe a microarray to determine binding site occupancy. Unlike ChIP, DamID does not require antibodies but makes use of adenine methylation near the protein's binding sites to selectively amplify those regions, introduced by expressing minute amounts of protein of interest fused to bacterial DNA adenine methyltransferase.
SNP detection. Identifying single nucleotide polymorphism among alleles within or between populations. Several applications of microarrays make use of SNP detection, including Genotyping, forensic analysis, measuring predisposition to disease, identifying drug-candidates, evaluating germline mutations in individuals or somatic mutations in cancers, assessing loss of heterozygosity, or genetic linkage analysis.
Alternative splicing detection. An ‘exon junction array design uses probes specific to the expected or potential splice sites of predicted exons for a gene. It is of intermediate density, or coverage, to a typical gene expression array (with 1-3 probes per gene) and a genomic tiling array (with hundreds or thousands of probes per gene). It is used to assay the expression of alternative splice forms of a gene. Exon arrays have a different design, employing probes designed to detect each individual exon for known or predicted genes, and can be used for detecting different splicing isoforms.
Fusion genes microarray. A fusion gene microarray can detect fusion transcripts, e.g., from cancer specimens. The principle behind this is building on the alternative splicing microarrays. The oligo design strategy enables combined measurements of chimeric transcript junctions with exon-wise measurements of individual fusion partners.
Tiling array. Genome tiling arrays consist of overlapping probes designed to densely represent a genomic region of interest, sometimes as large as an entire human chromosome. The purpose is to empirically detect expression of transcripts or alternatively splice forms which may not have been previously known or predicted.

In some embodiments, DNA microarrays may be used to measure changes in expression levels, to detect single nucleotide polymorphisms (SNPs), or to genotype, sequence or re-sequence genomes such as mutant genomes, described elsewhere herein.

In some embodiments, the compositions of the invention may not be in array format; that is, in some embodiments, substrates comprising a single capture probe may be made as a well. In addition, in some arrays, multiple substrates may be used, either of different or identical compositions. Thus, for example, large arrays may comprise a plurality of smaller substrates.

In some embodiments, the target sequences may be added to the array of capture probes under conditions suitable for the formation of hybridization complexes. A variety of hybridization conditions may be used according to the various aspects and embodiments described herein, including high, moderate and low stringency conditions; see for example Maniatis et al., Molecular Cloning: A Laboratory Manual, 2d Edition, 1989, and Short Protocols in Molecular Biology, ed. Ausubel, et al, hereby incorporated by reference. Stringent conditions are sequence-dependent and will be different in different circumstances. Typically, longer sequences hybridize specifically at higher temperatures. An extensive guide to the hybridization of nucleic acids is found in Tijssen, Techniques in Biochemistry and Molecular Biology—Hybridization with Nucleic Acid Probes, “Overview of principles of hybridization and the strategy of nucleic acid assays” (1993). In some embodiments, stringent conditions are selected to be about 5-10° C. lower than the thermal melting point (Tm) for the specific sequence at a defined ionic strength and pH. The Tm is the temperature (under defined ionic strength, pH and nucleic acid concentration) at which 50% of the probes complementary to the target hybridize to the target sequence at equilibrium (as the target sequences are present in excess, at Tm, 50% of the probes are occupied at equilibrium). In some embodiments, stringent conditions may be those in which the salt concentration is less than about 1.0 M sodium ion, or about 0.01 to 1.0 M sodium ion concentration (or other salts) at pH 7.0 to 8.3 and the temperature may be at least about 30° C. In some embodiments, stringent conditions may also be achieved with the addition of helix destabilizing agents such as formamide. Thus, in some embodiments, the assays are performed under stringency conditions, which provides for formation of the hybridization complex only in the presence of target. Stringency may be controlled, in some embodiments, by altering a step parameter that is a thermodynamic variable, including, but not limited to, temperature, formamide concentration, salt concentration, chaotropic salt concentration, pH and organic solvent concentration.

It is to be understood that because of the multi-step, iterative process employed herein, in some embodiments, there may be no need to adjust parameters to control for non-specific binding. The use of short ssDNA probes of, e.g., 9 to 24 bases coated with RecA and/or RecA-like protein provides a system for a homology recognition process that is much-improved in its efficiency and accuracy, as compared to systems using ssDNA probes greater than 24 bases.

In some embodiments, the assays may be performed under intermediate or low stringency conditions (as distinguished from the high stringency conditions described above), for example, lower temperature and higher salt concentrations.

In some embodiments, the sample comprising the double-stranded nucleic acid (e.g., dsDNA) target sequences and the array comprising the single-stranded nucleic acid (e.g., ssDNA) capture probes (at least one of which comprises the recombinase) are added together under conditions that allow the formation of hybridization complexes. Detection of these complexes may proceed in a wide variety of ways, depending on the label and density of the array. In some embodiments, when fluorescent labels are used, optical detectors such as CCD cameras or confocal microscopes are used. In addition, a number of other components may be present, including, for example, CPUs or other processors, keyboards or ports to provide for detection and quantification.

### Kits

The solid substrates, nucleic acids, proteins, and reagents described herein may also be provided in the form of kits. For example, in some embodiments, kits may comprise one or more reagents selected from the following: one or more prepared substrate (e.g., nucleic acid array), double-stranded nucleic acid (e.g., dsDNA), single-stranded nucleic acid (e.g., ssDNA) capture probes approximately 9 to 24 bases in length, RecA and/or RecA-like protein, buffer (e.g., Tris), salt/ions (e.g., Mg²⁺), DNA polymerase (e.g., Taq polymerase), deoxynucleoside triphosphates (dNTPs), ATP or non-hydrolyzable nucleoside triphosphates such as, for example, ATP[γS] (adenosine 5′-[γ-thio]triphosphate).

### EXAMPLES

### Example 1

### Coated ssDNA

A 10 μl reaction containing 50 mM Tris pH 7.5, 5 mM DTT, 1 mM MgCl², 5 mM spermidine-acetate, 6.6 mM creatine phosphate (USB), 0.4 units creatine kinase (Roche), 2.8 mM ATP, 2 nM-10 nM ssDNA oligonucleotide, and 3.4 μM RecAAE38K (Gene Check Inc.) is incubated at 37° C. for 15 min to coat the oligonucleotides with RecA.

### Microarray Detection

Coated ssDNAs are attached to a prepared solid substrate (e.g., a glass slide/chip). dsDNA of interest suspended in 1×TBST is added to the slide and incubated at 50° C. for 30 min to permit hybridization and capture of ssDNA immobilized to the slide. Following a 1×TBST wash, streptavidin-horseradish peroxidase (HRP) (2 μg/ml) is added and incubated at room temperature for 10 min. Slides are washed, followed by addition of tyramide-Cy3 (1:50 in amplification diluent, Perkin Elmer) and incubation continues at room temperature for 10 min. Slides are washed, centrifuged to dry, and scanned for Cy3 fluorescence (Perkin Elmer ScanExpress). Data is presented as averages of duplicate array spots measured for medial signal intensity minus background.

### EQUIVALENTS

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

All references, patents and patent applications disclosed herein are incorporated by reference with respect to the subject matter for which each is cited, which in some cases may encompass the entirety of the document.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A nucleic acid array, comprising:
a solid substrate that comprises a single-stranded nucleic acid bound to a recombinase,
wherein the recombinase catalyzes pairing of single-stranded nucleic acid with complementary regions of double-stranded nucleic acid.

2. The nucleic acid array of claim 1, wherein the recombinase is a RecA protein, a RecA homolog, or a RecA-like protein.

3. The nucleic acid array of claim 2, wherein the recombinase is RecA803, UvsX, Rad51A, Rad51B, Rad51C, Rad51D, XRCC2, XRCC3, Rad57, Dmc or combinations thereof.

4. The nucleic acid array of claim 1, wherein the recombinase is purified.

5. The nucleic acid array of claim 1, wherein the single-stranded nucleic acid is about 9 to about 24 nucleotides in length.

6. The nucleic acid array of claim 1, wherein the single-stranded nucleic acid is isolated single-stranded deoxyribonucleic acid.

7. The nucleic acid array of claim 1, wherein the single-stranded nucleic acid is covalently bound to the solid substrate.

8. The nucleic acid array of claim 1, wherein the solid substrate or a surface of the solid substrate is glass, nylon, plastic or silicon.

9. The nucleic acid array of claim 1, wherein the solid substrate is a nucleic acid chip or a bead.

10. The nucleic acid array of claim 1, wherein the solid substrate comprises about 100 to about 100,000 single-stranded nucleic acids per 1 cm² area of the substrate.

11. The nucleic acid array of claim 1, further comprising a non-hydrolyzable nucleoside triphosphate.

12. The nucleic acid array of claim 11, wherein the non-hydrolyzable nucleoside triphosphate is ATPγS, GTPγS or combinations thereof.

13. A kit, comprising the nucleic acid array of claim 1.

14. A kit, comprising:
a solid substrate that comprises a single-stranded nucleic acid or a double-stranded nucleic acid; and
a recombinase that catalyzes pairing of single-stranded nucleic acid with complementary regions of double-stranded nucleic acid.

15-21. (canceled)

22. A method, comprising:
providing a solid substrate that comprises a single-stranded nucleic acid bound to a recombinase; and
contacting the single-stranded nucleic acid with a double-stranded nucleic acid,
wherein the recombinase catalyzes pairing of single-stranded nucleic acid with complementary regions of double-stranded nucleic acid.

23-24. (canceled)

25. The method of claim 22, wherein the recombinase is a RecA protein, a RecA homolog or a RecA-like protein.

26. The method of claim 22, wherein the recombinase is RecA803, UvsX, Rad51A, Rad51B, Rad51C, Rad51D, XRCC2, XRCC3, Rad57, Dmc or combinations thereof.

27. (canceled)

28. The method of claim 22, wherein the single-stranded nucleic acid is about 9 to about 24 nucleotides in length.

29-38. (canceled)

39. A method, comprising:
providing a solid substrate that comprises a single-stranded nucleic acid;
coating the single-stranded nucleic acid with a recombinase; and
contacting the coated single-stranded nucleic acid with a double-stranded nucleic acid,
wherein the recombinase catalyzes pairing of single-stranded nucleic acid with complementary regions of double-stranded nucleic acid.

40. A method, comprising:
providing a solid substrate that comprises a double-stranded nucleic acid; and
contacting the double-stranded nucleic acid with a recombinase and a single-stranded nucleic acid,
wherein the recombinase catalyzes pairing of single-stranded nucleic acid with complementary regions of double-stranded nucleic acid.

41. (canceled)
